(19) United States
(12) Patent Application Publication
(10) Pub. No.: US 2026/0152278 A1
(43) Pub. Date: Jun. 4, 2026

(54) PROPELLER DEVICE

(71) Applicant: HONDA MOTOR CO., LTD., Tokyo (JP)

(72) Inventor: Kenta Uchida, Wako-shi (JP)

(21) Appl. No.: 19/404,121

(22) Filed: Dec. 1, 2025

(30) Foreign Application Priority Data
Dec. 3, 2024 (JP) 2024-210621

(51) Int. Cl. B64C 11/00; B64C 11/30; B64C 29/00

(52) U.S. Cl. CPC B64C 11/001; B64C 11/30; B64C 29/00

(57) ABSTRACT

A propeller device is provided with a propeller including a plurality of blades, and a pitch angle changing unit that changes a pitch angle of each blade. The propeller device is further provided with a duct, and a support member supported by an airframe. The duct includes a duct hub. The support member extends along a rotational axis of the propeller and supports the duct hub.

### CROSS-REFERENCE TO RELATED APPLICATIONS

This application is based upon and claims the benefit of priority from Japanese Patent Application No. 2024-210621 filed on December 3, 2024, the contents of which are incorporated herein by reference.

### BACKGROUND OF THE INVENTION

### FIELD OF THE INVENTION

The present disclosure relates to a propeller device.

### DESCRIPTION OF THE RELATED ART

US 11420762 B2 discloses a propeller device capable of changing the pitch angle of a plurality of blades. Specifically, the propeller device includes a control tube that is linearly moved by an actuator, and a crosshead provided at one end of the control tube. The plurality of blades are supported by the crosshead. The pitch angle of the plurality of blades is changed as the control tube and the crosshead integrally move linearly.

JP 2024-033168 A discloses a propeller device including a duct. In this case, the duct includes a tubular body surrounding the outer periphery of the propeller, and a duct hub and a duct stator that are located inside the tubular body. Air flows inside the tubular body. Inside the tubular body, the direction of flow of the air is a direction from the flight direction of the flying object (the front side) to the opposite direction to the flight direction (the rear side). The duct hub and the duct stator are disposed downstream of a plurality of blades in the direction of flow of the air.

### SUMMARY OF THE INVENTION

There has been a demand for a propeller device that includes both a duct and a pitch angle changing unit.

The present disclosure has the object of solving the above-described problem.

According to an aspect of the present disclosure, there is provided a propeller device that is provided in an airframe and generates lift or thrust for the airframe, the propeller device comprising: a propeller including a plurality of blades; a rotational driving force applying unit configured to apply a rotational driving force to the propeller; a pitch angle changing unit configured to change a pitch angle of the plurality of blades; a duct including a tubular body, a duct hub, and a duct stator, wherein the tubular body is configured to surround an outer periphery of the propeller, the duct hub is located inside the tubular body, the duct stator is configured to connect the duct hub and the tubular body, and the duct hub and the duct stator are disposed downstream of the propeller in an air flow direction in the tubular body; and a support member that is supported by the airframe, extends along a rotational axis of the propeller, and is configured to support the duct hub.

According to the present disclosure, the duct can be further provided in the propeller device that includes the pitch angle changing unit.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic perspective view of a vertical take-off and landing aircraft;

FIG. 2 is a schematic cross-sectional side view of a propeller device according to a first embodiment as viewed from a direction orthogonal to a rotational axis of a propeller;

FIG. 3 is a cross-sectional view taken along line III-III of FIG. 2;

FIG. 4 is a schematic cross-sectional side view of the propeller device in a state where a crosshead has moved forward, as viewed from the direction orthogonal to the rotational axis of the propeller;

FIG. 5 is a schematic view of a crosshead according to another embodiment; and

FIG. 6 is a schematic cross-sectional side view of a propeller device according to a second embodiment as viewed from the direction orthogonal to the rotational axis of the propeller.

### DETAILED DESCRIPTION OF THE INVENTION

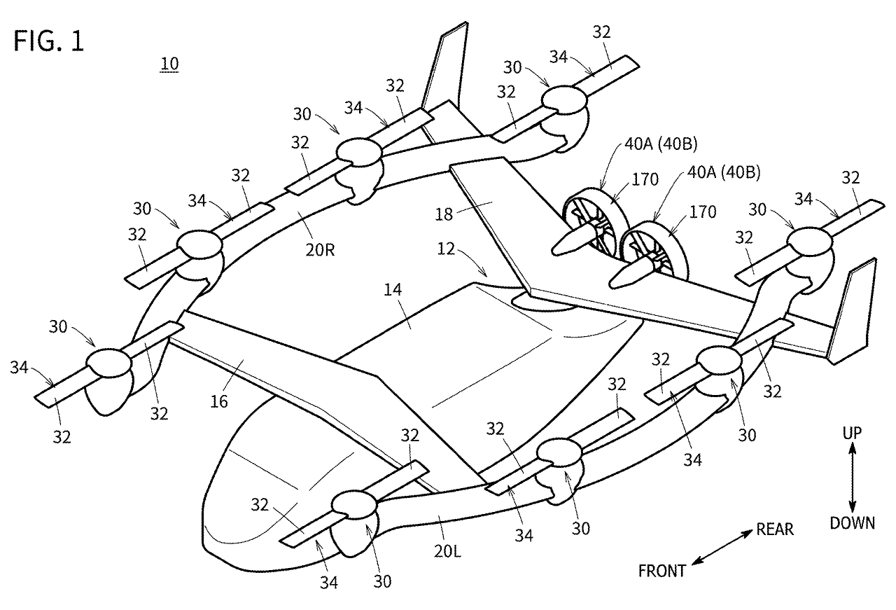

Hereinafter, a propeller device will be described by exemplifying a propeller device 40A mounted on a vertical take- off and landing aircraft (VTOL aircraft) 10 shown in FIG. 1. Although the VTOL aircraft 10 in the illustrated example is a passenger aircraft, the VTOL aircraft 10 may be an unmanned aerial vehicle such as a drone. In addition, a direction in which the VTOL aircraft 10 flies when cruising is defined as "forward", and a direction opposite to "forward" is defined as "rearward".

FIG. 1 is a schematic perspective view of the VTOL aircraft 10. The VTOL aircraft 10 includes an airframe 12, two propeller devices 40A, and eight lift generators 30. The airframe 12 includes a fuselage 14, a front wing 16, a rear wing 18, and two booms 20L and 20R. The two propeller devices 40A are provided on the rear wing 18. The two propeller devices 40A are each a so-called cruise rotor, and suck in atmosphere (air) in front of a plurality of blades 102 (a propeller 100) and discharge the air to the rear of the propeller 100. Each of the propeller devices 40A thereby generates thrust for the VTOL aircraft 10.

Four of the eight lift generators 30 are provided on the boom 20L. The remaining four of the eight lift generators 30 are provided on the boom 20R. The eight lift generators 30 are each a so-called VTOL rotor, and suck in atmospheric air above a plurality of blades 32 (a propeller 34) and discharge the atmospheric air to below the propeller 34. Each of the lift generators 30 thereby generates lift for the VTOL aircraft 10. It should be noted that the eight lift generators 30 may be configured in the same manner as the two propeller devices 40A.

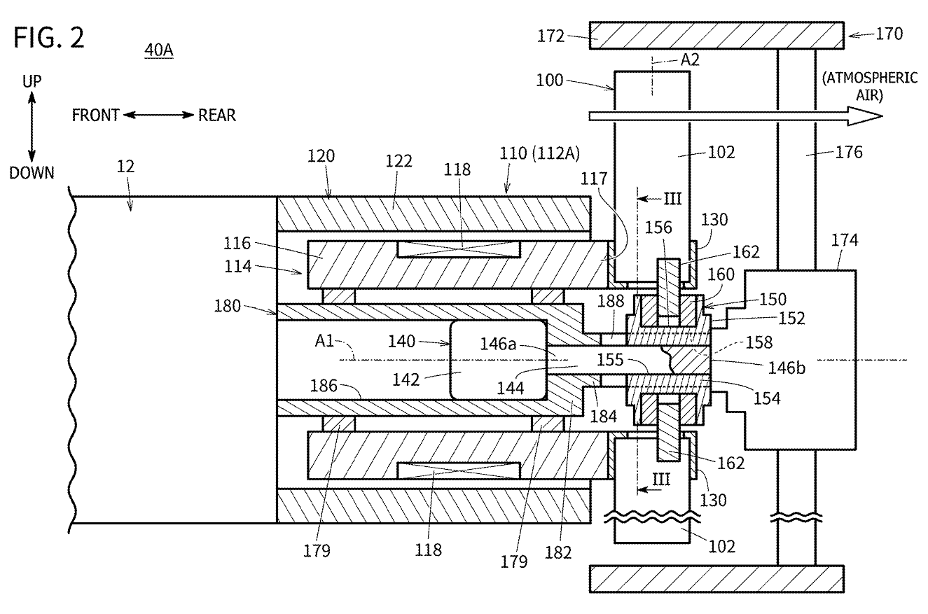

A description will be given concerning the propeller device 40A according to a first embodiment in which a rotational driving force applying unit 110 shown in FIG. 2 is constituted by a motor 112A. In this case, the VTOL aircraft 10 is a so- called eVTOL aircraft. However, the rotational driving force applying unit 110 is not limited to the motor 112A. The rotational driving force applying unit 110 may be an internal combustion engine.

FIG. 2 is a schematic cross-sectional side view of the propeller device 40A as viewed from a direction orthogonal to a rotational axis A1 of the propeller 100. The propeller device 40A includes the propeller 100. The propeller 100 includes the plurality of blades 102. The propeller device 40A further includes the motor 112A serving as the rotational driving force applying unit 110, and a pitch angle changing unit 140.

The motor 112A includes a rotor 114, and a stator 120 surrounding the outer periphery of the rotor 114. That is, the motor 112A in the illustrated example is a so-called inner rotor motor in which the rotor 114 is located inside the stator 120. The rotor 114 includes a rotating sleeve 116, and a plurality of permanent magnets 118 provided on the outer peripheral portion of the rotating sleeve 116. The stator 120 includes an electromagnetic coil 122.

The rotating sleeve 116 is rotatable about the rotational axis A1. A direction in which the rotational axis A1 extends coincides with the extending direction of the rotating sleeve 116. The rotating sleeve 116 has two end portions in the extending direction. One of the two end portions is close to the rear wing 18, which is a part of the airframe 12, and faces forward. The other of the two end potions is separated from the rear wing 18 and faces rearward. Hereinafter, the other end portion is referred to as a sleeve rear end 117.

The propeller 100 is provided at the sleeve rear end 117.

Specifically, a plurality of blade support portions 130 are provided at the sleeve rear end 117. A base portion, which is one end of each of the plurality of blades 102 in the longitudinal direction, is inserted into each of the plurality of blade support portions 130 and is pivotably supported by each of the plurality of blade support portions 130. The pivot center of each of the blades 102 is a blade axis A2. When the rotating sleeve 116 rotates, the propeller 100 rotates integrally with the rotating sleeve 116. The rotation center of the propeller 100 is located on the rotational axis A1. The longitudinal direction of each of the plurality of blades 102 is, for example, substantially orthogonal to the rotational axis A1.

The pitch angle changing unit 140 includes an actuator 142, a rod 144, and a crosshead 150. The rod 144 has a rod front end 146a that is one end thereof in the extending direction and faces the actuator 142, and a rod rear end 146b that is the other end thereof in the extending direction. The rod front end 146a is connected to the actuator 142, whereby the rod 144 is connected so as to extend rearward. In this state, the actuator 142 moves the rod 144 linearly. The moving direction of the rod 144 is forward or backward (the direction lying along the rotational axis A1 of the propeller 100).

The crosshead 150 includes a tubular portion 152 and a rod holding portion 154. In the illustrated example, a connecting hole 155 is formed in the rod holding portion 154. The rod rear end 146b is fixed to the connecting hole 155, whereby the rod 144 is connected to the rod holding portion 154. Alternatively, a threaded portion may be provided on the side surface of the rod rear end 146b. In this case, the threaded portion is passed through the connecting hole 155, and then a nut is screwed onto the threaded portion. As a result, the rod 144 is connected to the rod holding portion 154. In this manner, the rod 144 (the rod rear end 146b) is connected to the rod holding portion 154, and thus the crosshead 150 moves integrally with the rod 144.

A pin groove 156 is formed in the side surface of the crosshead 150. The pin groove 156 extends around the side surface along the circumferential direction of the side surface. A bearing 160 is inserted into the pin groove 156. The bearing 160 supports one end of each of a plurality of actuating pins 162. The other end of each of the actuating pins 162 is connected to the base portion of each blade 102. As the actuating pins 162 move integrally with the crosshead 150, the blades 102 pivot about the blade axis A2.

The propeller device 40A further includes a duct 170, and a support member 180 for supporting the duct 170 on the airframe 12. The support member 180 is a hollow cylindrical body that is located inside the rotor 114 and extends along the rotational axis A1. The support member 180 includes a large diameter portion 182 and a guide portion 184. The guide portion 184 is located rearward of the large diameter portion 182 and has a smaller diameter than the large diameter portion 182. One end of the large diameter portion 182 in the longitudinal direction (a front end of the support member 180) is supported by the airframe 12 (the fuselage 14, the rear wing 18, or the like). One end of the guide portion 184 in the longitudinal direction (the rear end of the support member 180) supports a duct hub 174 constituting the duct 170. In this state, the large diameter portion 182 supports the rotor 114 via a bearing 179.

The support member 180 includes an insertion hole 186 extending along the rotational axis A1. The axial position of the insertion hole 186 coincides with the rotational axis A1. The actuator 142 and the rod 144 are inserted into the insertion hole 186. The actuator 142 may be disposed outside the insertion hole 186.

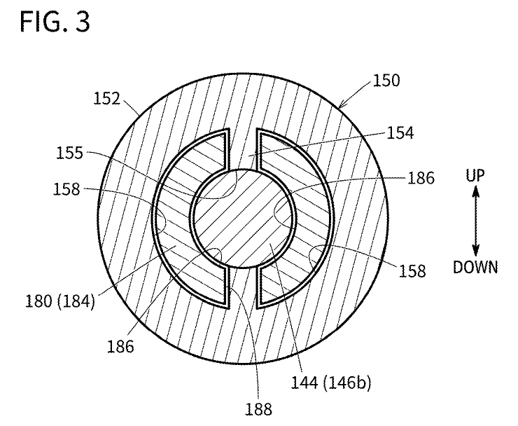

FIG. 3 is a cross-sectional view taken along line III-III of FIG. 2. As shown in FIG. 3, the guide portion 184 includes a slit 188. The slit 188 extends along the rotational axis A1. The tubular portion 152 of the crosshead 150 slidably covers the outer periphery of the guide portion 184. The rod holding portion 154 of the crosshead 150 protrudes from the tubular portion 152 toward the rod 144, and is passed through the slit 188. The extending direction of the rod holding portion 154 is a direction orthogonal to the rotational axis A1, and coincides with the diametrical direction of the support member 180. The rod holding portion 154 includes the connecting hole 155 at a position through which the rotational axis A1 passes. As described above, the rod rear end 146b is fixed to the connecting hole 155.

In the radial direction of the crosshead 150, an opening 158 having a substantially semicircular shape is formed between the tubular portion 152 and the rod holding portion 154. As shown in FIG. 2, one end of the guide portion 184 in the longitudinal direction (the rear end of the support member 180) is exposed rearward from the opening 158.

The duct 170 includes a tubular body 172, the duct hub 174, and a plurality of duct stators 176. The tubular body 172 has a substantially cylindrical shape and surrounds the outer periphery of the propeller 100. The duct hub 174 and the plurality of duct stators 176 are located inside the tubular body 172.

A front end portion of the duct hub 174 that faces forward is connected to one end of the guide portion 184 in the longitudinal direction (the rear end of the support member 180). Such a connection is made by joining such as welding, for example. Alternatively, the shape of the front end portion may be made to correspond to the shape of the slit 188, and the front end portion may be press-fitted into the slit 188.

The plurality of duct stators 176 extend radially from the duct hub 174 toward the inner surface of the tubular body 172, and connect the duct hub 174 and the tubular body 172. As described above, since the duct hub 174 is supported by the support member 180, the plurality of duct stators 176 are supported by the support member 180 via the duct hub 174, and the tubular body 172 is supported by the support member 180 via the plurality of duct stators 176 and the duct hub 174.

It should be noted that, in the duct 170, the direction in which air flows (the air flow direction) is from the front side to the rear side. Therefore, the front part of the duct 170 is located on the upstream side in the air flow direction. The rear part of the duct 170 is located on the downstream side in the air flow direction. As understood from FIG. 2, the duct hub 174 and the plurality of duct stators 176 are disposed downstream of the propeller 100 in the air flow direction. In the case where the eight lift generators 30 (see FIG. 1) are configured in the same manner as the propeller device 40A, each of the eight lift generators 30 includes the duct 170 configured as described above.

Next, the operation of the propeller device 40A will be described.

When the VTOL aircraft 10 is operated, first, the propellers 34 of the lift generators 30 (the VTOL rotors) are rotated. As a result, lift is generated for the VTOL aircraft 10, and the VTOL aircraft 10 takes off. When the VTOL aircraft 10 reaches a predetermined altitude, the propellers 100 of the propeller devices 40A (the cruise rotors) are then rotated. Specifically, the motors 112A, which are the rotational driving force applying units 110, are energized. Accordingly, the rotating sleeves 116 and the propellers 100 rotate integrally. The rotation of the propellers 100 generates thrust for the VTOL aircraft 10, and the VTOL aircraft 10 flies forward.

In each of the propeller devices 40A, the atmospheric air is sucked into the tubular body 172 from the front opening of the tubular body 172 in accordance with the rotation of the propeller 100. The atmospheric air sucked into the tubular body 172 is discharged from the rear opening of the tubular body 172. As described above, in the tubular body 172, the duct hub 174 and the duct stators 176 are located downstream of the propeller 100 in the air flow direction. Therefore, as disclosed in JP 2024-033168 A, noise of the propeller device 40A is suppressed.

In accordance with the rotation of the propeller 100, the plurality of actuating pins 162 rotate along the pin groove 156. Since the plurality of actuating pins 162 are supported by the bearing 160, the plurality of actuating pins 162 are prevented from being worn. Incidentally, when the propeller 100 rotates, the rod 144 and the crosshead 150 do not rotate.

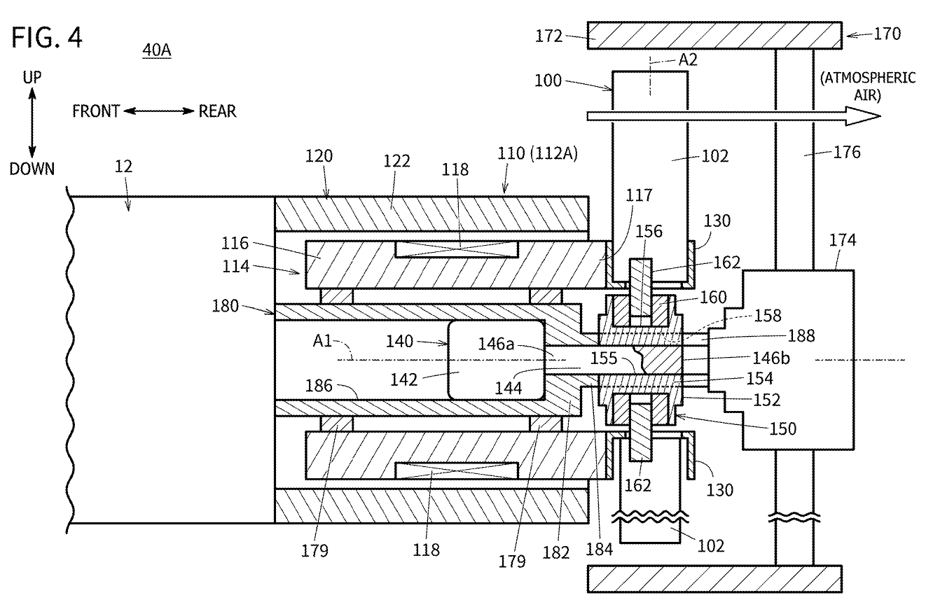

In the case where the pitch angle of the plurality of blades 102 is changed, the operator operates the actuator 142 by means of remote control. As a result, for example, as shown in FIG. 4, the rod 144 and the crosshead 150 integrally move forward. Accordingly, the plurality of actuating pins 162 held by the crosshead 150 move forward in an arc shape. As described above, each actuating pin 162 is connected to the base portion of each blade 102 held by the blade support portion 130. Therefore, each blade 102 pivots. As a result, the pitch angle of each blade 102 is changed.

In the case where the blades 102 are pivoted toward the original position, the operator operates the actuator 142 by means of remote control, and integrally moves the rod 144 and the crosshead 150 rearward as shown in FIG. 2. As a result, each blade 102 pivots toward the original position. This causes the pitch angle of each blade 102 to be changed again.

As described above, the propeller devices 40A each include the pitch angle changing unit 140 for changing the pitch angle of each blade 102, and also include the duct 170. That is, according to the first embodiment, the propeller devices 40A each including both the pitch angle changing unit 140 and the duct 170 can be configured.

The first embodiment has the following effects.

As shown in FIG. 2, the propeller device 40A includes the pitch angle changing unit 140 for changing the pitch angle of the plurality of blades 102. The propeller device 40A further includes the duct 170 including the tubular body 172, the duct hub 174, and the duct stators 176. Inside the tubular body 172, the duct hub 174 and the duct stators 176 are located downstream of the plurality of blades 102 (the propeller 100) in the air flow direction.

In this manner, according to the first embodiment, the duct 170 can be further provided in the propeller device 40A that includes the pitch angle changing unit 140.

The pitch angle changing unit 140 includes the crosshead 150. When the pitch angle of each blade 102 is changed, the crosshead 150 can move while being guided by the guide portion 184 of the support member 180 that supports the duct hub 174. By this movement of the crosshead 150, the pitch angle of the plurality of blades 102 is changed via the actuating pins 162.

Since the crosshead 150 is guided by the guide portion 184 (the support member 180) in this manner, the crosshead 150 is prevented from moving while being displaced from the rotational axis A1. Therefore, each blade 102 can be pivoted to have a desired pitch angle.

The pitch angle changing unit 140 includes the rod 144 to which the crosshead 150 is connected. On the other hand, the support member 180 includes the insertion hole 186 extending along the rotational axis A1 of the propeller 100. The rod 144 is inserted into the insertion hole 186 so as to be movable relative to the support member 180.

By accommodating the rod 144 in the insertion hole 186 in this manner, the propeller device 40A can be downsized as compared to a case where the rod 144 is disposed outside the support member 180.

As shown in FIG. 3, the support member 180 includes the slit 188 extending along the rotational axis A1. On the other hand, the crosshead 150 includes the rod holding portion 154 that is passed through the slit 188 and is positioned in the insertion hole 186. The rod 144 is connected to the rod holding portion 154.

With such a configuration, the rod 144 inserted into the insertion hole 186 can be easily connected to the crosshead 150.

As shown in FIG. 2, the crosshead 150 includes the tubular portion 152. The tubular portion 152 extends along the rotational axis A1 outside the insertion hole 186. The rod holding portion 154 protrudes from the tubular portion 152 toward the rod 144.

In this case, the inner surface of the tubular portion 152 is in contact with the outer surface of the guide portion 184 of the support member 180. Accordingly, the posture of the crosshead 150 is stabilized. Therefore, the rod 144 is prevented from being axially displaced from the rotational axis A1.

The motor 112A is an inner rotor motor in which the rotor 114 is located inside the stator 120. The support member 180 supports the rotor 114 via the bearing 179 inside the rotor 114.

According to such a configuration, in the case where the inner rotor motor (the motor 112A) is used as the rotational driving force applying unit 110, the rotor 114 can be reliably rotated. In addition, the duct 170 can be supported by the support member 180.

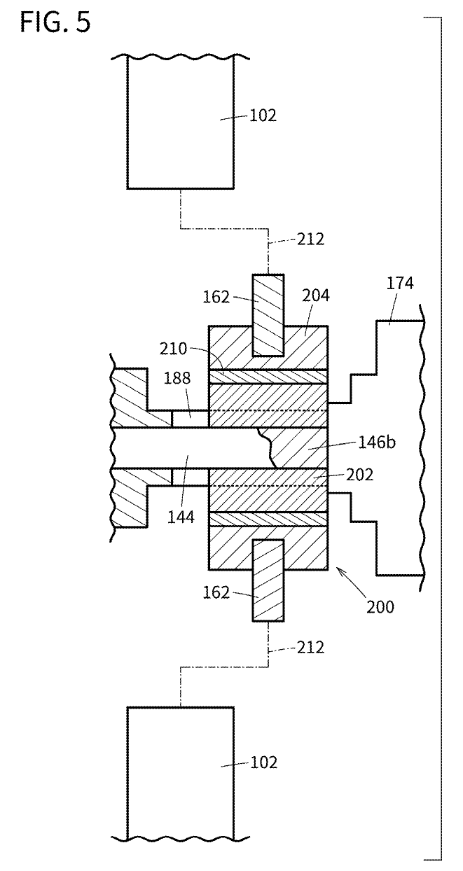

A crosshead 200 shown in FIG. 5 may be used instead of the crosshead 150. This aspect will be described.

The crosshead 200 includes an inner member 202 and an outer member 204. The inner member 202 is positioned and fixed to the outer peripheral surface of the rod rear end 146b of the rod 144. The outer member 204 is located on the outer periphery of the inner member 202 in the radial direction of the rod 144, and overlaps the inner member 202 via a crosshead bearing 210. The crosshead bearing 210 interposed between the inner member 202 and the outer member 204 is, for example, a self-aligning bearing.

The plurality of actuating pins 162 are respectively connected to the plurality of blades 102 via, for example, link mechanisms 212. However, the link mechanisms 212 are not essential.

When the propeller 100 rotates in accordance with the rotation of the rotating sleeve 116, the actuating pins 162 and the outer member 204 rotate integrally with the rotating sleeve 116. On the other hand, since the crosshead bearing 210 is interposed between the inner member 202 and the outer member 204, the inner member 202 does not rotate. Further, the rod 144 also does not rotate.

In the case where the pitch angle of each blade 102 is changed, the rod 144 and the inner member 202 integrally move. In accordance therewith, the crosshead bearing 210 and the outer member 204 move in the same direction as the inner member 202. As a result, the actuating pins 162 move in an arc shape. This causes each blade 102 to pivot. Based on this pivoting, the pitch angle of each blade 102 is changed.

An outline of another aspect different from the above will be described as a modification. In the modification, the rod 144 is a hollow body, and the support member 180 is passed through the hollow interior of the rod 144. That is, contrary to FIG. 2, the support member 180 is located on the inner peripheral side of the rod 144. In this case, the rear end of the support member 180 is exposed from the rod rear end 146b, and the duct hub 174 is supported by the rear end of the support member 180.

In a case where the actuator 142 interferes with the support member 180 if the actuator 142 is disposed on the rotational axis A1, the actuator 142 is disposed at a position deviated from the rotational axis A1. Further, the actuator 142 and the rod 144 are connected to each other via, for example, a gear train. As a result, the rod 144 can be moved by the actuator 142 while avoiding interference of the support member 180 with the actuator 142.

In this modification as well, each blade 102 pivots as the rod 144 and the crosshead 150 integrally move forward or rearward in the same manner as described above. As a result, the pitch angle of each blade 102 is changed. Note that, in this aspect, the crosshead 150 is not guided by the support member 180.

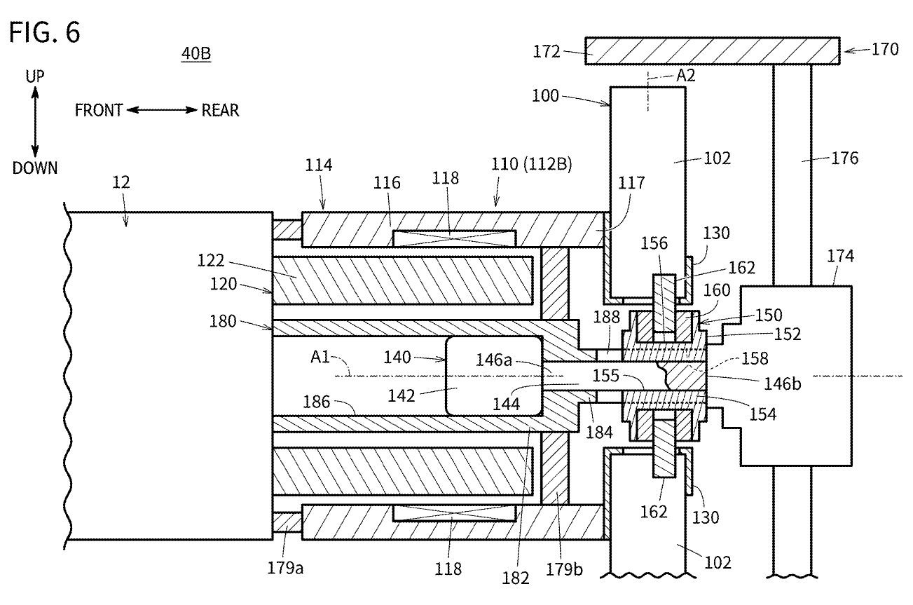

Next, a propeller device 40B according to a second embodiment will be described with reference to FIG. 6. It should be noted that the same constituent elements as those shown in FIGS. 1 to 4 are denoted by the same reference numerals, and detailed description thereof will be omitted.

In the propeller device 40B, a motor 112B includes the stator 120, and the rotor 114 surrounding the outer periphery of the stator 120. That is, the motor 112B shown in FIG. 6 is a so-called outer rotor motor in which the stator 120 is located inside the rotor 114. The rotor 114 includes the rotating sleeve 116, and the plurality of permanent magnets 118 provided on the inner peripheral portion of the rotating sleeve 116. The stator 120 includes the electromagnetic coil 122. A bearing 179a is interposed between the airframe 12 (the fuselage 14 or the rear wing 18) and an end portion of the rotor 114 that faces forward.

In the second embodiment, the support member 180 is located inside the stator 120 and extends along the rotational axis A1. The large diameter portion 182 of the support member 180 supports the rotor 114 via a bearing 179b.

In the second embodiment as well, as in the first embodiment, each blade 102 pivots as the rod 144 and the crosshead 150 integrally move forward or rearward. As a result, the pitch angle of each blade 102 is changed.

Therefore, according to the second embodiment, the same effects as those of the first embodiment can be obtained.

Further, the motor 112B of the second embodiment is an outer rotor motor in which the stator 120 is located inside the rotor 114. That is, according to the second embodiment, in the case where the outer rotor motor (the motor 112B) is used as the rotational driving force applying unit 110, the rotor 114 can be reliably rotated. In addition, the duct 170 can be supported by the support member 180.

In the second embodiment, the crosshead 200 shown in FIG. 5 may be used. Further, in the second embodiment, the rod 144 may be a hollow body and the support member 180 may be passed through the hollow interior of the rod 144, based on the above-described modification.

The following supplementary notes are further disclosed in relation to the above-described embodiments.

### Supplementary Note 1

The propeller device (40A, 40B) of the present disclosure is a propeller device that is provided in the airframe (12) and generates lift or thrust for the airframe, the propeller device including: the propeller (100) including the plurality of blades (102); the rotational driving force applying unit (110) configured to apply a rotational driving force to the propeller; the pitch angle changing unit (140) configured to change the pitch angle of the plurality of blades; the duct (170) including the tubular body (172), the duct hub (174), and the duct stator (176), wherein the tubular body is configured to surround the outer periphery of the propeller, the duct hub is located inside the tubular body, the duct stator is configured to connect the duct hub and the tubular body, and duct hub and the duct stator are disposed downstream of the propeller in the air flow direction inside the tubular body; and the support member (180) that is supported by the airframe, extends along the rotational axis (A1) of the propeller, and is configured to support the duct hub.

According to such a configuration, the duct can be further provided in the propeller device that includes the pitch angle changing unit.

### Supplementary Note 2

In the propeller device according to Supplementary Note 1, the pitch angle changing unit may include the crosshead (150, 200) configured to change the pitch angle by pivoting the plurality of blades, and when changing the pitch angle of the plurality of blades, the crosshead may move while being guided by the support member.

In this case, the crosshead is guided by the support member when moving. Therefore, since the crosshead moves along the rotational axis, the pitch angle of the plurality of blades can be changed to a desired pitch angle.

### Supplementary Note 3

In the propeller device according to Supplementary Note 1 or 2, the pitch angle changing unit may include the crosshead (150, 200) configured to change the pitch angle by pivoting the plurality of blades, and the rod (144) connected to the crosshead, the support member may include the insertion hole (186) extending along the rotational axis, and the rod may be inserted into the insertion hole so as to be movable relative to the support member.

In this case, the propeller device can be easily downsized as compared to a case where the rod is disposed outside the support member.

### Supplementary Note 4

In the propeller device according to Supplementary Note 3, the support member may include the slit (188) extending along the rotational axis, the crosshead may include the rod holding portion (154) configured to be passed through the slit and positioned in the insertion hole, and the rod may be connected to the rod holding portion.

According to this configuration, the rod inserted into the insertion hole and the crosshead can be easily connected to each other.

### Supplementary Note 5

In the propeller device according to Supplementary Note 4, the crosshead may include the tubular portion (152) extending along the rotational axis outside the insertion hole, and the rod holding portion may protrude from the tubular portion toward the rod.

In this case, since the inner surface of the tubular portion is in contact with the outer surface of the support member, the posture of the crosshead is stabilized. Therefore, the rod is prevented from being axially displaced from the rotational axis.

### Supplementary Note 6

In the propeller device according to any one of Supplementary Notes 1 to 5, the rotational driving force applying unit may be the motor (112A, 112B) including the stator (120) and the rotor (114), and the support member may rotatably support the rotor via the bearing (179, 179b).

In the case where a motor is used as the rotational driving force applying unit, the rotor and the propeller can be reliably rotated. In addition, the duct can be supported by the support member.

Although the present disclosure has been described in detail, the present disclosure is not limited to the above-described individual embodiments. Various additions, replacements, modifications, partial deletions, and the like can be made to these embodiments without departing from the essence and gist of the present disclosure, or without departing from the essence and gist of the present disclosure derived from the claims and equivalents thereof. Further, these embodiments can also be implemented in combination. For example, in the above-described embodiments, the order of operations and the order of processes are shown as examples, and are not limited to these. Furthermore, the same applies to a case where numerical values or mathematical expressions are used in the description of the above-described embodiments.

1. A propeller device that is provided in an airframe and generates lift or thrust for the airframe, the propeller device comprising:
a propeller including a plurality of blades;
a rotational driving force applying unit configured to apply a rotational driving force to the propeller;
a pitch angle changing unit configured to change a pitch angle of the plurality of blades;
a duct including a tubular body, a duct hub, and a duct stator, wherein the tubular body is configured to surround an outer periphery of the propeller, the duct hub is located inside the tubular body, the duct stator is configured to connect the duct hub and the tubular body, and the duct hub and the duct stator are disposed downstream of the propeller in an air flow direction in the tubular body; and
a support member that is supported by the airframe, extends along a rotational axis of the propeller, and is configured to support the duct hub.

2. The propeller device according to claim 1, wherein
the pitch angle changing unit includes a crosshead configured to change the pitch angle by pivoting the plurality of blades, and
when changing the pitch angle of the plurality of blades, the crosshead moves while being guided by the support member.

3. The propeller device according to claim 1, wherein
the pitch angle changing unit includes: a crosshead configured to change the pitch angle by pivoting the plurality of blades; and a rod connected to the crosshead,
the support member includes an insertion hole extending along the rotational axis, and
the rod is inserted into the insertion hole so as to be movable relative to the support member.

4. The propeller device according to claim 3, wherein
the support member includes a slit extending along the rotational axis,
the crosshead includes a rod holding portion configured to be passed through the slit and positioned in the insertion hole, and
the rod is connected to the rod holding portion.

5. The propeller device according to claim 4, wherein
the crosshead includes a tubular portion extending along the rotational axis outside the insertion hole, and
the rod holding portion protrudes from the tubular portion toward the rod.

6. The propeller device according to claim 1, wherein
the rotational driving force applying unit is a motor including a stator and a rotor, and
the support member rotatably supports the rotor via a bearing.

7. A flying object comprising:
an airframe; and
a propeller device provided in the airframe and configured to generate lift or thrust for the airframe,
wherein the propeller device includes:
a propeller including a plurality of blades;
a rotational driving force applying unit configured to apply a rotational driving force to the propeller;
a pitch angle changing unit configured to change a pitch angle of the plurality of blades;
a duct including a tubular body, a duct hub, and a duct stator, wherein the tubular body is configured to surround an outer periphery of the propeller, the duct hub is located inside the tubular body, the duct stator is configured to connect the duct hub and the tubular body, and the duct hub and the duct stator are disposed downstream of the propeller in an air flow direction in the tubular body; and
a support member that is supported by the airframe, extends along a rotational axis of the propeller, and is configured to support the duct hub.

8. The flying object according to claim 7, wherein
the flying object is a vertical take-off and landing aircraft.
